(19) United States
(12) Patent Application Publication
(10) Pub. No.: US 2015/0004478 A1
(43) Pub. Date: Jan. 1, 2015

(54) Novel Method For Gold Plated Termination of Hermetic Device

(71) Applicants: Joseph M. Prinzbach, North Tonawanda, NY (US); Lou Serpe, Clarence Center, NY (US); Gary Freitag, East Aurora, NY (US); David E. Smith, Lockport, NY (US)

(72) Inventors: Joseph M. Prinzbach, North Tonawanda, NY (US); Lou Serpe, Clarence Center, NY (US); Gary Freitag, East Aurora, NY (US); David E. Smith, Lockport, NY (US)

(73) Assignee: Greatbatch Ltd., Clarence, NY (US)

(21) Appl. No.: 13/097,454

(22) Filed: Apr. 29, 2011

Related U.S. Application Data
(60) Provisional application No. 61/329,165, filed on Apr. 29, 2010.

(51) Int. Cl. H01M 2/06; H01G 9/008; H01M 10/04

(52) U.S. Cl. 429/181; 29/623.1; 29/623.5; 29/25.03

(57) ABSTRACT

An electrochemical cell comprising a hermetic glass-to-metal seal utilizing a gold coated terminal lead is described. The surface of the terminal lead is directly coated with a layer of gold utilizing an electroplating method. The improved process improves manufacturing efficiencies and reliability of the electrochemical cell.

### CROSS-REFERENCE TO RELATED APPLICATIONS

This application claims priority from U.S. Provisional Patent Application Ser. No. 61/329,165, filed Apr. 29, 2010.

### FIELD OF THE INVENTION

The present invention generally relates to the conversion of chemical energy to electrical energy and, more particularly, to a glass-to-metal seal (GTMS) for hermetically sealing an electrochemical cell. The glass-to-metal seal is considered critical because it hermetically isolates the internal environment of a component. from the external environment to which the component is exposed. In electrochemical cells powering implantable medical devices, the GTMS hermetically seals the internal cell chemistry from the external device environment.

### PRIOR ART

Glass-to-metal seals of electrochemical cells generally consist of a ferrule sleeve secured to an opening in the cell casing, such as in the lid or in the casing body itself. The ferrule supports an insulating glass in a surrounding relationship and the glass in turn seals around the perimeter of a terminal lead. The terminal lead extends from inside the cell to a position outside the casing, and serves as the lead for one of the cell electrodes. Typically the terminal lead is connected to the cathode current collector. The casing including the lid serves as the second terminal for the other electrode, typically the anode. This configuration is referred to as a case-negative design.

To construct a glass-to-metal seal, insulating glass is provided in a ring shape to fit inside the ferrule sleeve or inside an opening in the casing body in a closely spaced relationship. The insulating glass has a hole through its center that receives the terminal lead in a closely spaced relationship. These components are assembled and then heated in a furnace. This heating step causes the glass to soften and flow into intimate contact with the inside of the ferrule and with the perimeter of the terminal lead. When the assembly cools, the insulating glass is bonded to the ferrule and the terminal lead.

Typically a layer of gold is applied to the surface of the terminal lead. This gold layer is beneficial in that it provides the terminal lead with a nonreactive surface that inhibits oxidation and provides for good electrical connection.

The current process requires that a layer of nickel is first adhered to the surface of the terminal lead. The nickel acts as an intermediary layer that promotes gold adhesion to the surface. The application of this nickel layer means that a heat treating step be performed requiring the nickel layer be exposed to a temperature greater than the temperatures used to melt the sealing glass. Application of this nickel under-plate layer is therefore limited prior to the glass melting sealing process to prevent undesirable glass melting due to the nickel heat treating temperature.

Furthermore, a nickel to gold layer combination on the surface of the terminal lead is not desirable prior to the glass-to-metal thermal treatment process. When the nickel to gold layer combination, is subjected to the elevated temperatures of the glass sealing process, an undesirable nickel-gold inter-metallic alloy typically forms on the surface. This nickel-gold inter-metallic alloy makes the surface of the terminal lead susceptible to deleterious oxidation. This oxidation layer generally impedes adhesion of the gold layer to the surface of the terminal lead. Furthermore, this oxidation layer degrades electrical conduction. Therefore, to overcome these complications, the gold layer is generally applied to the lead surface after the glass sealing process that forms the hermetic seal. This limitation of the prior process adds additional cost and hinders design flexibility of the cell.

In addition, it is generally accepted that nickel undesirably reacts with the chemistries within the electrochemical cell. Such chemical reactions could result in degradation of the cell's electrical performance. Therefore, the prior assembly process requires exacting precision, in the placement of the lead within the cell, to ensure the nickel coated surface is not exposed to the electrolytes within the cell.

Furthermore, the prior process requires that the gold layer be in contact with the nickel layer beneath. If the gold layer is not in contact with nickel, it is likely that a portion of the gold will not adhere to the surface of the lead. Such a lack of gold layer coverage on the surface of the lead. may result in other electrical performance issues of the cell and/or device as previously mentioned.

What is desired is an electrochemical cell and manufacturing process thereof which incorporates an improved terminal lead gold plating process that provides a more efficient manufacturing process and improved reliability of the cell. Therefore, the gold plating process of the surface of the terminal lead has been improved through the elimination of the nickel under-plate layer as embodied in the present invention.

### SUMMARY OF THE INVENTION

The present invention is directed to a modified gold surface treatment of the terminal lead of an electrochemical cell. In the present invention, the nickel under plate layer is eliminated and a layer of gold is directly applied to the surface of the terminal lead. The modified process of the current invention provides for a gold plated terminal lead that withstands glass sealing temperatures, thereby enabling a more efficient and robust glass-to-metal electrochemical cell manufacturing process. In addition, the modified process of the current invention improves cell reliability and design flexibility.

Elimination of the nickel under plate layer allows for the terminal lead, or a portion thereof, to be gold plated prior to assembly of the cell. Therefore, the need to control the precise placement of the nickel under-plate layer within the electrochemical cell is eliminated. As a result, the manufacturing process of the electrochemical cell is simplified and made more cost effective.

In addition, safety and reliability of the electrochemical cell is improved. Elimination of the nickel under-plate layer eliminates the possibility of an undesirable reaction between the nickel metal and electrolyte chemistry within the cell. This undesirable reaction has been generally known to cause electrical performance and reliability issues within the cell.

These and other features of the present invention will become increasingly more apparent to those of ordinary skill in the art by reference to the following description and the appended drawings.

### BRIEF DESCRIPTION OF THE DRAWINGS

FIG. 1 is an illustration of a cross section of an exemplary electrochemical cell of the present invention.

FIG. 2 is a cross-sectional view of an exemplary glass-to-metal seal having a ferrule supporting the insulating glass.

FIG. 3 is a cross-sectional view of an exemplary glass-to-metal seal having the glass sealed directly to the casing.

FIG. 4A is a process flow chart of the prior art electrochemical cell assembly process.

FIG. 4B is a process flow chart of the electrochemical cell assembly process of the present invention.

FIG. 5 is a process flow chart of the modified gold plating process of the present invention.

### DETAILED DESCRIPTION OF THE PREFERRED EMBODIMENTS

A typical hermetic glass-to-metal seal consists of a terminal lead electrically isolated from a ferrule or casing body by an insulating glass. The individual materials chosen for these applications are critical and must meet the following design criteria. First, the surface of the terminal lead must be corrosion resistant to the internal cell chemistry, be weldable and modifiable for attachment to the end users product. In addition, the surface should have sufficient electrical conductivity for the particular cell design. Secondly, the insulating glass needs to be corrosion resistant to the internal cell chemistry, and have sufficient electrical resistivity for the particular cell design. Lastly, the ferrule or casing body must be corrosion resistant to the internal cell chemistry, have sufficient electrical conductivity for the particular cell design, and be weldable for secondary operations.

When these components are manufactured into a glass-to-metal seal, accomplished by assembling the components together followed by heating in a furnace, the resultant seal must also meet the following design criteria: the assembly must be hermetic, and the insulating glass and terminal lead must exhibit acceptable visual characteristics. It is preferably desired that the surface of the terminal lead be free from oxidation, discolorations, blemishes and cosmetic defects. It is also desired that the glass adhere to the surface of the terminal lead, have no cracks that affect function, and there must be sufficient electrical resistivity between the ferrule or casing body and the terminal lead for the cell design. Also, the glass-to-metal seal must exhibit acceptable thermal resistance to secondary processing such as welding and it must be mechanically tolerant to secondary processing such as terminal lead bending.

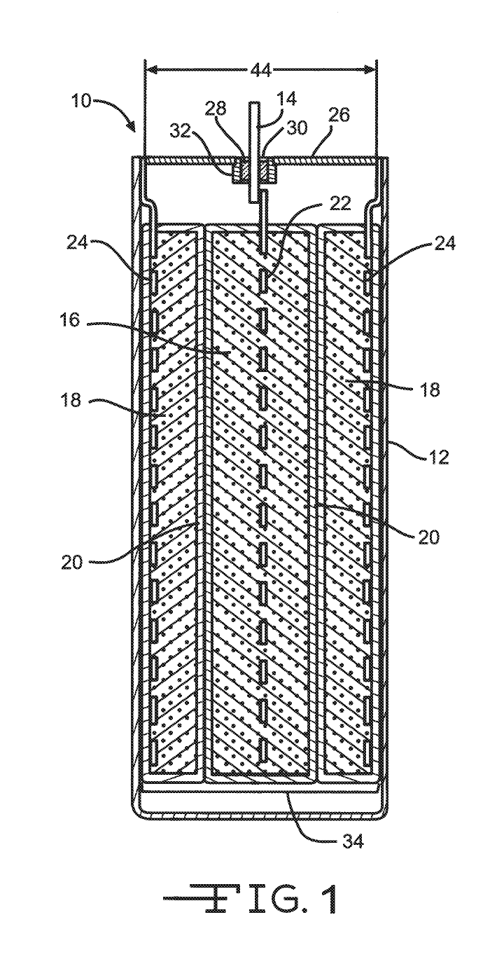

Turning now to the drawings, FIGS. 1 to 3, show exemplary embodiments of glass-to-metal seals of the present invention. As already discussed, it is not the specific configuration of the various components of the seals, but the process of construction which delineates the prior art from the present invention seals.

FIG. 1 illustrates a cross-sectional view of an exemplary electrochemical cell 10 of the present invention. This illustrated exemplar may either be of a primary (non rechargeable) or secondary (rechargeable) electrochemical cell 10. The electrochemical cell 10 comprises a casing 12, a terminal lead 14, a cathode electrode 16, an anode electrode 18, and a separator 20 therebetween. As shown, a cathode current collector 22 connects the cathode 16 to the terminal lead 14. An anode current collector 24 connects the anode 18 to the casing 12 and/or a lid 26 at the top of the cell 10. An electrolyte solution. fills the casing 12 and provides a means for ion transfer between the anode 18 and the cathode 16.

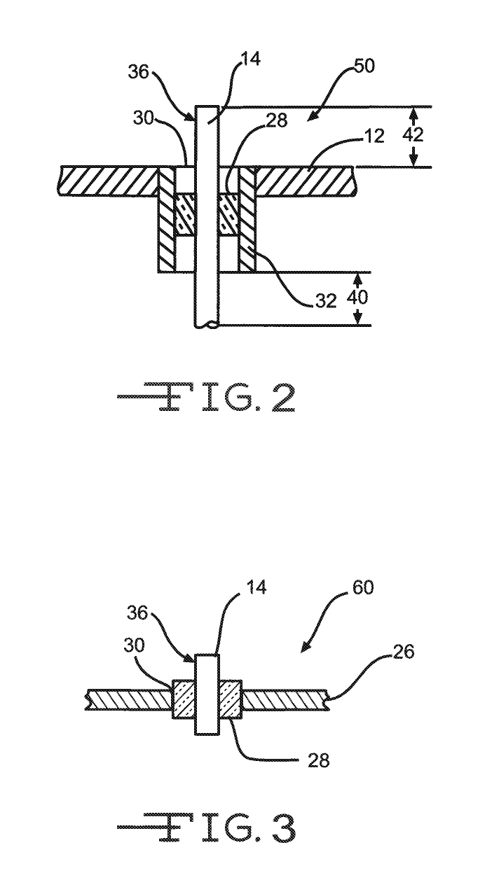

FIG. 2 illustrates an exemplary embodiment of a glass-to-metal seal 50 consisting of a casing 12 having an opening 30 sized to receive a ferrule 32. The casing 12 can be the casing body itself or the lid 26 secured to the open end of a container housing the electrode assembly 34, (FIG. 1) as is well known by those of ordinary skill in the art. The ferrule 32 is a cylindrically-shaped member hermetically secured to the casing 12 in the opening 30, such as by welding. Preferably, the upper end of the ferrule 32 is flush with the outer surface of the casing 12. The ferrule 32 extends into the interior of the casing 12 and supports an insulating glass 28 surrounding the perimeter of the terminal lead 14. The terminal lead 14 is coaxial with the ferrule 32 with a distal end portion 40 extending into the interior of the casing 12. The distal end. portion 40 is connected to one of the electrodes 16, 18, typically the current collector 22 of the cathode electrode 16. The proximal end portion 42 of the terminal lead 14 extends above the ferrule 32 and the outer surface of the casing 12 and provides for connection to one of the terminals of the load which the cell 10 is intended to power.

The other lead of the cell 10 is provided by the casing electrically connected to the anode electrode 18. This electrode configuration is referred to as a case-negative design. As is well known by those of ordinary skill in the art, the cell 10 can also be provided in a case-positive configuration. In that case, the terminal lead 14 is connected to the anode current collector 24 and the cathode electrode 16 is electrically connected to the casing 12.

In any event, the glass 28 must be sufficiently resistive to electrically segregate the casing 12 from the terminal lead 14 but be sealed to and between the ferrule 32 and the terminal lead 14. This sealing relationship must be sufficiently hermetic so that the cell 10 is useful in applications such as powering implantable medical devices.

Suitable insulting glasses 28 are those glass compositions that create a hermetic seal. This insulating glass 28 may be in the form. of a frit or cut glass tubing. Glass-to-metal seals can be of a matched seal where the coefficients of thermal expansions of all of the materials of construction are reasonably similar. Another type of glass-to metal seal comprises those in which the coefficient of thermal expansion of the ferrule sleeve 32 or of the casing body 12 is higher than that of the insulating glass 28 while the coefficients of thermal expansion of the terminal lead 14 and the insulating glass 28 are substantially the same. Compression type glass-to-metal seals are shown in U.S. Pat. No. 3,225,132 to Baas et al., U.S. Pat. No. 4,053,692 to Dey, U.S. Pat. No. 4,430,376 to Box and U.S. Pat. No. 4,587,144 to Kellerman et al.

Furthermore, the glass-to-metal seal can be of a reverse mismatched compression seal where the coefficient of thermal expansion of the insulating glass 28 is less than that of the terminal lead 14. Typically in a reverse mismatch compression seal, the ferrule 32 or casing body 12 has a coefficient of thermal expansion which is substantially similar to significantly greater than that of the terminal lead 14 as described by Frysz et al. in U.S. Pat. No. 6,759,163, incorporated herein. It is preferred that the insulting glass 28 comprise CABAL-12 which is commercially available from Sandia National Laboratories. Other non-limiting examples of insulting glasses include FUSITE 435 and TA-23.

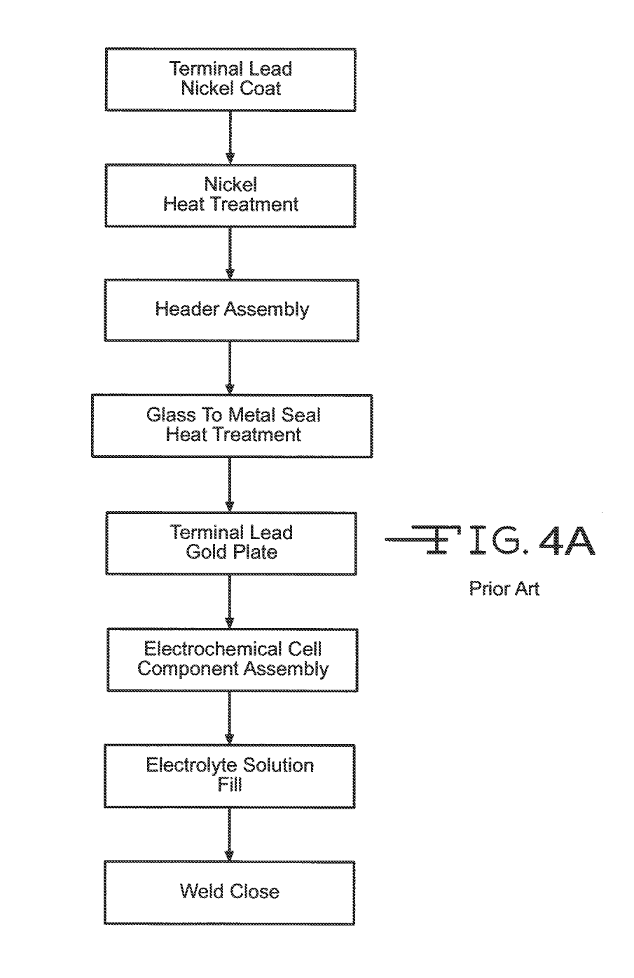

FIG. 3 shows another embodiment of an exemplary glass-to-metal seal 60 devoid of a ferrule. This assembly includes a terminal lead 14 sealed directly into an opening 30 in the lid 26 by an insulating glass 28. Alternatively, the lid 26 can be the casing 12 itself or a portion of the casing 12. Terminal leads 14, such as those of the present invention, are typically composed of an electrically conductive metal. Preferably, the terminal lead 14 is comprised of molybdenum and/or associated molybdenum alloys. However, the terminal lead 14 can also be comprised of other electrically conductive metals such as stainless steel, high ferritic stainless steel, titanium, niobium, tantalum, and their associated alloys.

In that respect, the process of construction for both the exemplary embodiments of glass-to-metal seals shown in FIGS. 1-3, must meet the various criteria set forth above. The present invention improves upon the prior gold plating process as previously discussed. Unlike the prior method of plating gold over an under-plate layer of nickel, the surface 36 of the terminal lead 14 is directly plated with a layer of gold without the nickel under-plate, utilizing an electroplating process.

The electroplating process of the present invention provides for an electrochemical cell 10 and manufacturing process thereof that is more cost effective and robust than the prior process. As previously mentioned, elimination of the nickel layer does away with the need for a high temperature nickel heat treatment process and removes the possibility of electrical performance degradation due to nickel content exposure to the electrolyte within the cell 10.

It is generally known that the nickel layer can be oxidized by the cathode material to form nickel ions. These nickel ions dissolve in the electrolyte solution and diffuse in all directions within the cell 10. Typically in a case-negative cell construction, these nickel ions migrate to the ferrule 32 where they electrochemically reduce to form nickel metal. The formed nickel metal generally deposits on the surface of the ferrule 32. As the nickel metal continues to deposit, a nickel metal “bridge” forms across the ferrule insulation band extending toward the terminal lead 14. Ultimately an electrical short could result depleting the cell 10.

In a preferred embodiment of the present invention, a layer of gold is applied directly to the surface 36 of the terminal lead 14 prior to assembly of the cell 10 and prior to exposure of the glass-to-metal seal temperatures.

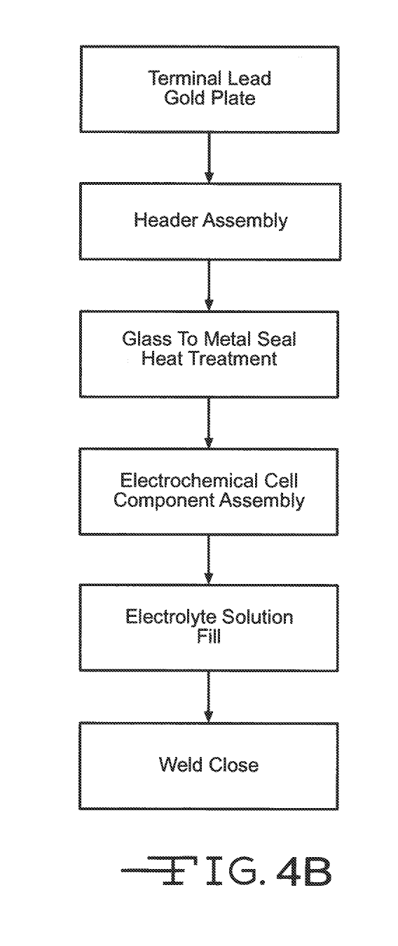

FIG. 4A details the prior art electrochemical cell 10 assembly process that utilizes a nickel under-plate layer glass-to-metal seal. As shown in the flow chart, the terminal lead 14 is first coated with a layer of nickel metal. This nickel layer is then heat treated at a temperature ranging from about 800° C. to about 1000° C. for about 10 to about 30 minutes. The nickel heat treatment promotes adhesion, of the nickel under-plate layer to the surface 36 of the lead 14.

The nickel coated terminal lead is then incorporated into a header assembly 44 (FIG. 1). The header assembly 44 comprises the lead 14 and the lid 26 or top portion of the case 12 of the electrochemical cell 10. The nickel coated lead is carefully placed. through an opening 30 of the casing 12 or lid 26. Insulating glass 28 is then placed around the perimeter of the terminal lead 14 and the header assembly 44 is heat treated to form the glass-to-metal seal. After the seal is formed, the layer of gold is applied to the nickel under plate layer on the nickel surface of the terminal lead. Once the layer of gold is formed, the electrode assembly 34 and remaining components of the electrochemical cell 10 are assembled in the casing 12.

In contrast, FIG. 48 illustrates a preferred assembly process flow chart of the electrochemical cell 10 of the present invention. As shown in the flow chart, a portion of the surface 36 of the terminal lead 14 is first electroplated with a layer of gold. In a preferred embodiment, the layer of gold covers a proximal portion 42 of the surface 36 of the terminal lead 14, extending outside the casing 12 or above the lid 26. However, it is contemplated that the entire outer surface 36 of the terminal lead 14, from the proximal portion 42 to a distal portion 40, can also be covered by the layer of gold. It is preferred that the layer of gold have a thickness from about 0.01 um to about 25 um, more preferably from about 0.2 um to about 10 um, and most preferably from about 0.5 um to about 5 um.

After the application of the layer of gold on the surface 36 of the terminal lead 14 is complete, the lead 14 is then incorporated into the electrochemical cell 10. The gold coated lead 14 is placed through an opening 30 of the casing 12 or lid 26 comprising the header assembly 44. Insulating glass 28 is placed around the perimeter of the lead 14 and the assembly of the lead 14, casing 12 and/or lid 26 is subjected to a heat treatment that melts the glass 28 and hermetically seals the header assembly 44. The other components of the cell 10 such as the anode 18, and cathode 16 are placed in the casing 12 of the cell 10. The electrolyte solution is then injected into the casing 12 and the electrochemical cell 10 is welded together completing the assembly process of the cell 10.

In comparing the prior art process to that of the present invention, it can be seen that the assembly method of the present invention affords a more simplified, efficient process. The elimination of the nickel under-plate layer and associated nickel layer processes, reduce manufacturing costs and eliminates potential processing errors caused by the nickel under-plate layer as previously discussed. In addition, the method of the present invention creates a more robust process whereby the gold coated terminal lead 14 can be easily placed anywhere within the electrochemical cell 10. Since the nickel has been removed, there is no possibility of electrolyte exposure to nickel. As such, the elimination of the nickel layer eliminates this potential factor of electrical performance degradation and further increases the design robustness within the cell 10.

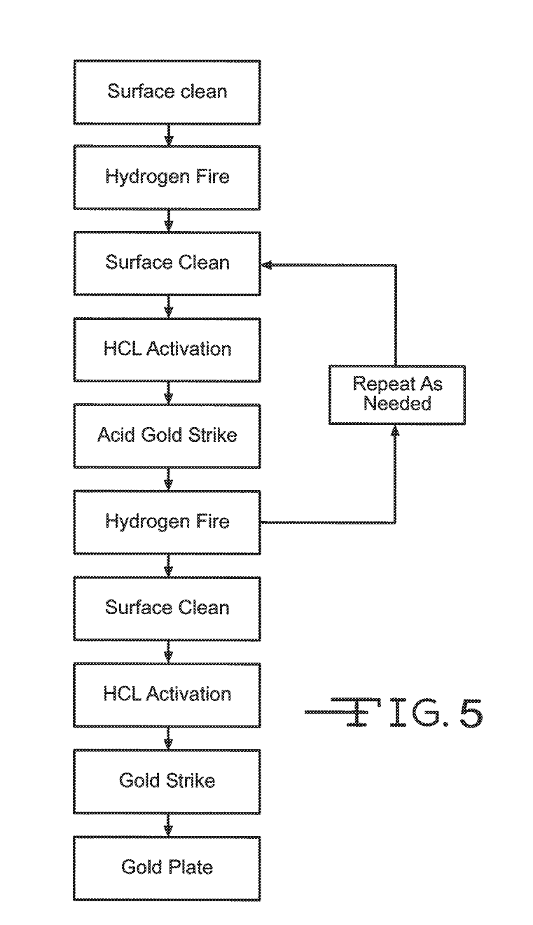

As previously discussed, a preferred feature of the present invention is that the surface 36 of the terminal lead 14 is directly coated with a layer of gold via an electroplating process. FIG. 5 illustrates the process flow of this preferred electroplating process.

As shown by the flow chart, the electroplating process begins with cleaning the surface 36 of the terminal lead 14. It is preferred that a combination of water and an alkaline cleaner be used as a cleaning agent. Once cleaned, the surface 36 of the lead 14 is heat treated in a hydrogen atmosphere to further remove any possible contamination from the surface 36 of the lead 14. In a preferred embodiment, the surface 36 of the lead 14 is subjected to a temperature ranging from about 800° C. to about 1000° C. for about 3 to about 30 minutes in a hydrogen atmosphere (“Hydrogen Fire”). More preferably, the surface 36 of the lead 14 is subjected to a temperature ranging from about 850° C. to about 1000° C. for about 5 to about 20 minutes in a hydrogen. atmosphere. Alternatively, an abrasive blasting process could also be used to remove surface contamination from the surface 36 of the lead 14.

The surface 36 of the lead 14 is then cleaned once again using a combination of water and cleaning agent such as the one previously described, After the surface 36 of the lead 14 is cleaned, the surface 36 is then activated with hydrochloric acid (HCL). This HCL activation step further removes surface contaminants and prepares the surface 36 for adhesion of the initial layer or layers of gold. After the surface 36 of the lead 14 has been activated, the surface 36 is subjected to an acid gold strike which applies the initial layer or layers of gold. It is preferred that the acid gold strike step preferably comprise an acidic cyanide gold.

After application of the initial layer of gold is complete, the surface 36 of the terminal lead 14 is then heat treated in a hydrogen atmosphere (“Hydrogen Fire”). In a preferred embodiment, the surface 36 of the lead 14 is subjected to a temperature ranging from about 800° C. to about 1000° C. for about 10 to about 30 minutes in a hydrogen atmosphere. This heat treatment step enhances adhesion of the gold layer to the surface 36 of the lead 14, particularly that of molybdenum. However, other commonly used materials for the terminal lead 14 of an electrochemical cell 10 other than molybdenum, such as stainless steel, high ferritic stainless steel, titanium, niobium, tantalum, and their associated alloys, as previously mentioned, are also useful with the present invention.

The surface 36 of the terminal lead 14 is cleaned again using the previously described cleaning agent. if desired, the hydrochloric acid (HCL) activation, acid gold strike, and hydrogen fire steps can be repeated as required to develop additional layers of gold.

Once an adequate initial layer or layers of gold are adhered to the surface 36, the lead 14 is prepared for final gold plating. Once the surface 36 of the lead 14 is cleaned, the surface 36 is again activated using hydrochloric acid (HCL). After which, a gold strike comprising either an acid gold, a neutral gold, or a basic gold is then applied to the surface 36 of the lead 14. Finally, the surface 36 of the lead 14 is subjected to a gold plating step that increases the gold layer to a final desired thickness. It is understood that these gold electroplating process steps may be modified by one of ordinary skill in art. It is preferred however that the electroplating process achieve a gold layer thickness of about 0.01 um to about 25 um, more preferably from about 0.2 um to about 10 um, and most preferably from about 0.5 um to about 5 um, that is directly adhered to the surface 36 of the terminal lead 14.

By way of example, in an illustrative cell 10, as shown in FIG. 1, according to the present invention, an anode active material is an alkali metal selected from Group IA of the Periodic Table of Elements is contacted to a nickel current collector 24.

The cathode active material is of a carbonaceous material, fluorinated carbon, metal, metal oxide, mixed metal oxide or a metal sulfide, and mixtures thereof. Preferably, the cathode material is mixed with a conductive diluent such as carbon black, graphite or acetylene black or metal powders such as nickel, aluminum, titanium and stainless steel, with a fluro-resin powder binder material such as powered polytetrafluroethylene or powdered polyvinylidene fluoride. The thusly prepared cathode active mixture is contacted to the cathode current collector 22 which is a thin sheet or metal screen, for example, a titanium, stainless steel, aluminum or nickel screen.

The separator 20 is of an electrically insulative material, and the separator material also is chemically unreactive with the anode and cathode active materials and both chemically unreactive with and insoluble in the electrolyte. In addition, the separator material has a degree of porosity sufficient to allow flow therethrough of the electrolyte during the electrochemical reaction of the cell 10. Illustrative separator materials include woven and unwoven fabrics of polyolefinic fibers or fluoropolymeric fibers including polyvylidine fluoride, poiyethylenetetrafluoroethylene, and polyethylenechlorotrifluoroethylene laminated or superposed with a polyolefinic or fluoropolymeric microporous film. Suitable microporous films include a polytetrafluoroethylene membrane commercially available under the designation ZITEX (Chemplast Inc.), polypropylene membrane commercially available under the designation CELGARD (Celanese Plastic Company, Inc.) and a membrane commercially available under the designation DEXIGLAS (C. H. Dexter, Div., Dexter Corp.). The separator 20 may also be composed of non-woven glass, glass fiber materials and ceramic materials.

The exemplary cell 10 of the present invention. having the direct gold layer adhered to the surface 36 of the terminal lead 14, is activated with an ionically conductive electrolyte which serves as a medium for migration of ions between the anode 18 and the cathode 16 electrodes during the electrochemical reactions of the cell 10. By way of example, a suitable electrolyte for an alkali metal active anode has an inorganic or organic, ionically conductive salt dissolved in a nonagueous solvent, and more preferably, the electrolyte includes an ionizable alkali metal salt dissolved in a mixture of aprotic organic solvents comprising a low viscosity solvent and a high permittivity solvent. The ionically conductive salt serves as the vehicle for migration of the anode ions to intercalate or react with the cathode active material. Preferably the ion-forming alkali metal salt is similar to the alkali metal comprising the anode 18.

A preferred material for the casing 12 is stainless steel although titanium, mild steel, nickel-plated mild steel and aluminum are also suitable. The casing header comprises a metallic lid 26 having a sufficient number of openings 30 to accommodate the glass-to-metal seal having the terminal lead 14 connected to the cathode electrode 16. An additional opening (not shown) is provided for electrolyte filling. The casing lid. 26 comprises elements having compatibility with the other components of the electrochemical cell 10 and is resistant to corrosion. The cell 10 is thereafter filled with the electrolyte solution described hereinabove and hermetically sealed such as by close-welding a stainless steel plug over the fill hole opening, but not limited thereto. The cell 10 of the present invention can also be constructed in a case-positive design.

Further, the cell 10 of the present invention having the gold coated surface 36 of the terminal lead 14 is readily adaptable to secondary, rechargeable electrochemical chemistries. A typical negative electrode for a secondary cell is fabricated by mixing about 90 to 97 weight percent “hairy carbon” (U.S. Pat. No 5,443,928 to Takeuchi at al.) or graphite with about 3 to 10 weight percent of a binder material, which is preferably a fluoro-resin powder such as polytetrafluoroethylene (PTFE), polyvinylidene fluoride (PVDF), polyethylenetetrafluoroethylene (ETFE), polyamides, polyimides, and mixtures thereof. This negative electrode admixture is provided on a current collector 22, 24 such as of a nickel, stainless steel, or copper foil or screen by casting, pressing, rolling or otherwise contacting the admixture thereto.

In secondary cells 10, the positive electrode 16 preferably comprises a lithiated material that is stable in air and readily handled. Examples of such air-stable lithiated cathode active materials include oxides, sulfides, selenides, and tellurides of such metals as vanadium, titanium, chromium, copper, molybdenum, niobium, iron, nickel, cobalt and manganese. The more preferred oxides include LiNiO₂, LiMn₂O₄, LiCoO₂, LiCO_{0.92}SnO_{0.08}O₂ and LiCo₁₋ₓNiₓO₂. The secondary cell chemistry is activated by the previously described electrolytes.

To charge such secondary cells 10, the lithium metal comprising the positive electrode 16 is intercalated into the carbonaceous negative electrode by applying an externally generated electrical potential to the cell 10. The applied recharging electrical potential serves to draw lithium ions from the cathode active material, through the electrolyte and into the carbonaceous material of the negative electrode 18 to saturate the carbon. The resulting LiₓC₆ negative electrode 18 can have an x ranging between 0.1 and 1.0. The cell 10 is then provided with an electrical potential and is discharged in a normal manner.

It is appreciated that various modifications to the invention concepts described herein may be apparent to those skilled in the art without departing from the spirit and the scope of the present invention defined by the hereinafter appended claims.

The resulting glass-to-metal seal is a hermetic seal with a terminal lead 14 in which a layer of gold is directly electroplated onto its surface 36. However, the resulting seal provides all of the critical design criteria for the use in an electrochemical cell 10 of the type intended to power an implantable medical device.

1. An electrochemical cell, comprising:
a) a casing;
b) a first electrode and a second, opposite polarity electrode housed within the casing and activated by an electrolyte;
c) a molybdenum terminal lead, comprising:
i) an intermediate lead portion extending between and to an inside lead portion located inside the casing and an outside lead portion located outside the casing,
ii) wherein the outside lead portion extends distally beyond an outer surface of the casing, and
iii) wherein the inside lead portion is electrically connected to a current collector for one of the first electrode and the second electrode;
d) an insulating glass sealing from the intermediate lead portion of the terminal pin to an opening in the casing to thereby electrically insulate the terminal lead from the casing; and
e) a layer of gold directly contacting and substantially confined to the outside lead portion of the molybdenum terminal lead.

2. The electrochemical cell of claim 1 wherein the first electrode is an anode and the second electrode is a cathode and wherein, the inside lead portion of the molybdenum lead is electrically connected to a cathode current collector for the cathode.

3. (canceled)

4. (canceled)

5. The electrochemical cell of claim 1 wherein the layer of gold is characterized as having been electroplated directly onto the outside lead portion of the molybdenum terminal lead.

6. The electrochemical cell of claim 1 wherein the layer of gold has a thickness from about 0.01 um to about 25 um.

7. The electrochemical cell of claim 1 wherein the layer of gold has a thickness from about 0.5 um to about 5 um.

8. (canceled)

9. The electrochemical cell of claim i wherein the first electrode is an anode comprised of an alkali metal selected from Group IA of the Periodic Table of Elements and the second electrode is a cathode of a cathode active material selected from the group consisting of a carbonaceous material, a fluorinated carbon, a metal, a metal oxide, a mixed metal oxide, a metal sulfide, and mixtures thereof.

10.-24. (canceled)

25. An electrochemical cell, consisting essentially of:
a) a casing comprising a container housing having an opening closed by a lid;
b) an anode housed within and electrically connected to the casing;
c) a cathode housed within the casing;
d) an separator preventing direct physical contact between. the anode and the cathode;
e) an electrolyte activating the anode and the cathode;
f) a molybdenum terminal lead, comprising:
i) an intermediate lead portion extending between and to an inside lead portion located inside the casing and an outside lead portion located outside the casing,
ii) wherein the outside lead portion extends beyond an outer surface of the lid comprising the casing, and
iii) wherein the inside lead portion is electrically connected to a cathode current collector for the cathode;
g) an insulating glass sealing from the intermediate lead portion of the terminal pin to an opening in the lid comprising the casing to thereby electrically insulate the terminal lead from the casing; and
h) a layer of gold directly contacting the outside lead portion of the molybdenum terminal lead.

26. The electrochemical cell of claim 25 wherein the layer of gold is characterized as having been electroplated directly onto the outside lead portion of the molybdenum terminal lead.

27. The electrochemical cell of claim 25 wherein the layer of gold has a thickness from about 0.01 um to about 25 um.

28. The electrochemical cell of claim 25 wherein the layer of gold has a thickness from about 0.5 um to about 5 um.

29. The electrochemical cell of claim 25 wherein the anode comprised of an alkali metal selected from Group IA of the Periodic Table of Elements and the cathode is of a cathode active material selected from the group consisting of a carbonaceous material, a fluorinated carbon, a metal, a metal oxide, a mixed metal oxide, a metal sulfide, and mixtures thereof.

30. An electrochemical cell, comprising:
a) a casing;
b) an anode housed within and electrically connected to the casing;
c) a cathode housed within the casing;
d) an separator preventing direct physical contact between the anode and the cathode;
e) an electrolyte activating the anode and the cathode;
f) a terminal lead comprised of a metal selected from the group consisting of molybdenum, stainless steel, high ferritic stainless steel, titanium, niobium, tantalum, and combinations thereof, wherein the terminal lead comprises:
i) an intermediate lead portion extending between and to an inside lead portion located inside the casing and an outside lead portion located outside the casing, and
ii) wherein the outside lead portion extends distally beyond an outer surface of the casing, and
iii) wherein the inside lead portion is electrically connected to a cathode current collector for the cathode;
g) an insulating glass sealing from the intermediate lead portion of the terminal in to an opening in the casing to thereby electrically insulate the terminal lead from the casing; and
h) a layer of gold directly contacting and substantially confined to the outside lead portion of the terminal lead.

31. The electrochemical cell of claim 30 wherein the layer of gold is characterized as having been electroplated directly onto the outside lead portion of the terminal lead.

32. The electrochemical cell of claim 30 wherein the layer of gold has a thickness from about 0.01 um to about 25 um.

33. The electrochemical cell of claim 30 wherein the layer of gold has a thickness from about 0.5 um to about 5 um.

34. The electrochemical cell of claim 30 wherein the anode comprised of an alkali metal selected from Group IA of the Periodic Table of Elements and the cathode is of a cathode active material selected from the group consisting of a carbonaceous material, a fluorinated carbon, a metal, a metal oxide, a mixed metal oxide, a metal sulfide, and mixtures thereof.
